(19) United States
(12) Patent Application Publication
(10) Pub. No.: US 2006/0243821 A1
(43) Pub. Date: Nov. 2, 2006

(54) Heated windshield washer fluid system

(76) Inventors: Richard Derin, Thornhill (CA); William Batt, Newmarket (CA); Ross Hill, Whitby (CA)

Correspondence Address: Jay S. Paranjpe;Clark Hill PLC, Suite 3500, 500 Woodward Avenue, Detroit, MI, 48226-3435, US

(21) Appl. No.: 11/119,251

(22) Filed: Apr. 29, 2005

(51) Int. Cl. B05B 1/24

(52) U.S. Cl. 239/132.1; 239/284.1

(57) ABSTRACT

A heated washer fluid assembly for heating washer fluid is provided to clean a windshield of a motor vehicle. The motor vehicle includes an engine and a fluid reservoir. The heated washer fluid assembly includes a first conduit has a receiving end fluidly connected to the fluid reservoir and an opposing delivery end for transferring washer fluid from the fluid reservoir to the delivery end. The first conduit also includes a middle segment disposed between the receiving and delivery ends and abutting a portion of the engine such that washer fluid passing through the middle segment is heated by the heat generated by the engine. The heated washer fluid assembly also includes a blanket covering said middle segment of said first conduit and the portion of the engine for insulating the heated washer fluid in said middle segment of said first conduit.

### FIELD OF THE INVENTION

The invention relates to a heated washer fluid system for a motor vehicle. More particularly, the invention relates to a heated washer fluid system that utilizes heat generated by an internal combustion engine to heat a quantity of washer fluid.

### DESCRIPTION OF RELATED ART

Windshield washer systems for cleaning a windshield of a motor vehicle are a standard feature in motor vehicles. Such windshield washer systems include a reservoir disposed within an engine compartment for storing washer fluid. Typically, a quantity of washer fluid is transferred from the reservoir to spray nozzles adjacent a bottom edge of the windshield. The spray nozzles dispense the washer fluid onto an external surface of the windshield. In a majority of weather conditions, the windshield washer system is a reliable means for cleaning the windshield. However, in cold weather conditions, i.e., temperatures below freezing, the same windshield washer system is less beneficial in that the washer fluid is prone to instantaneous icing when sprayed onto the cold windshield, which may make the windshield opaque.

In response to this problem, various systems have been developed for heating the washer fluid before the washer fluid arrives at the spray nozzles. Each of the existing systems utilizes a heat exchanger or similar device to heat the washer fluid. For example, U.S. Pat. No. 3,632,042 is directed to a heated windshield washer system including a heater means or conduit that is in a heat exchange relationship with washer fluid in an engine compartment reservoir and throughout its path of movement from the reservoir. The conduit includes a flexible hose portion having one end connected to a heater hose means and an opposing end connected to a conduit portion including a generally W-shaped section disposed within the reservoir. When an engine is running, heated engine coolant flows from the heater hose means through the conduit portion disposed within the reservoir. As a result, the washer fluid is heated via conduction while in the reservoir and is heated throughout its path of movement from the reservoir to the nozzle means.

U.S. Pat. No. 5,183,099 discloses a motor vehicle having an internal combustion engine, an engine coolant circuit, and a windshield washer system. The engine coolant circuit includes two segments of a radiator inlet hose, a radiator, and a radiator outlet hose. A connection device connects the two segments of the radiator inlet hose. A washer fluid reservoir and first and second segments of a washer fluid line are provided for supplying washer fluid to a windshield. The first segment leads from the reservoir to the connection device, and the second segment leads from the connection device to washer fluid nozzles. The connection device has a heating device for heating the washer fluid. The heating device includes a rigid internal tube that is in contact with a heat exchanger coil, and an external envelope element. The external envelope element is formed from either a polymer material of the elastomer type or of a thermoplastic or thermosetting polymer material.

U.S. Pat. No. 5,522,453 is directed to a washer fluid heater that is operatively connected to a heater hose extending between a water-cooled engine and a heater box. The heater hose is cut to produce two free ends and the washer fluid heater is interposed between the free ends. The washer fluid heater includes a housing having an inner wall that defines a washer fluid chamber. A central heating conduit passes through the washer fluid chamber. When an engine is started, engine coolant circulates through the central heating conduit. Washer fluid is pumped into the washer fluid chamber, in contact with the central heating conduit. As a result, a supply of washer fluid is heated and stored in the washer fluid chamber. When a vehicle washer system is activated, hot washer fluid leaves the washer fluid chamber and is applied to the glass surface to be cleaned.

U.S. Pat. No. 6,719,215 discloses a windshield washer system including a pump assembly that picks up fluid from a reservoir upon activation of a motor in order to convey the fluid to a nozzle for spraying on a windshield. The pump assembly includes a pump housing having a pump motor and pump element. A heater is mounted in proximity to the pump assembly to impart heat to the pump housing in order to prevent liquid from freezing therein.

In light of the foregoing examples, it would be desirable to provide a system that provides heated washer fluid without utilizing an additional heat exchanger.

### SUMMARY OF THE INVENTION

According to one aspect of the invention, a heated washer fluid assembly for heating washer fluid is provided to clean a windshield of a motor vehicle having an engine and a fluid reservoir. The heated washer fluid assembly includes a first conduit having a receiving end fluidly connected to the fluid reservoir and an opposing delivery end for transferring washer fluid from the fluid reservoir to the delivery end. The first conduit also includes a middle segment disposed between the receiving and delivery ends and abutting a portion of the engine such that washer fluid passing through the middle segment is heated by the heat generated by the engine. The heated washer fluid assembly also includes a blanket covering said middle segment of said first conduit and the portion of the engine for insulating the heated washer fluid in said middle segment of said first conduit.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a fragmentary, perspective view of a motor vehicle including an engine compartment and a heated washer fluid assembly according to the invention disposed therein; and

FIG. 2 is a side view of an engine having a manifold with a first conduit of the heated washer fluid assembly wrapped therearound.

### DETAILED DESCRIPTION OF THE PREFERRED EMBODIMENT

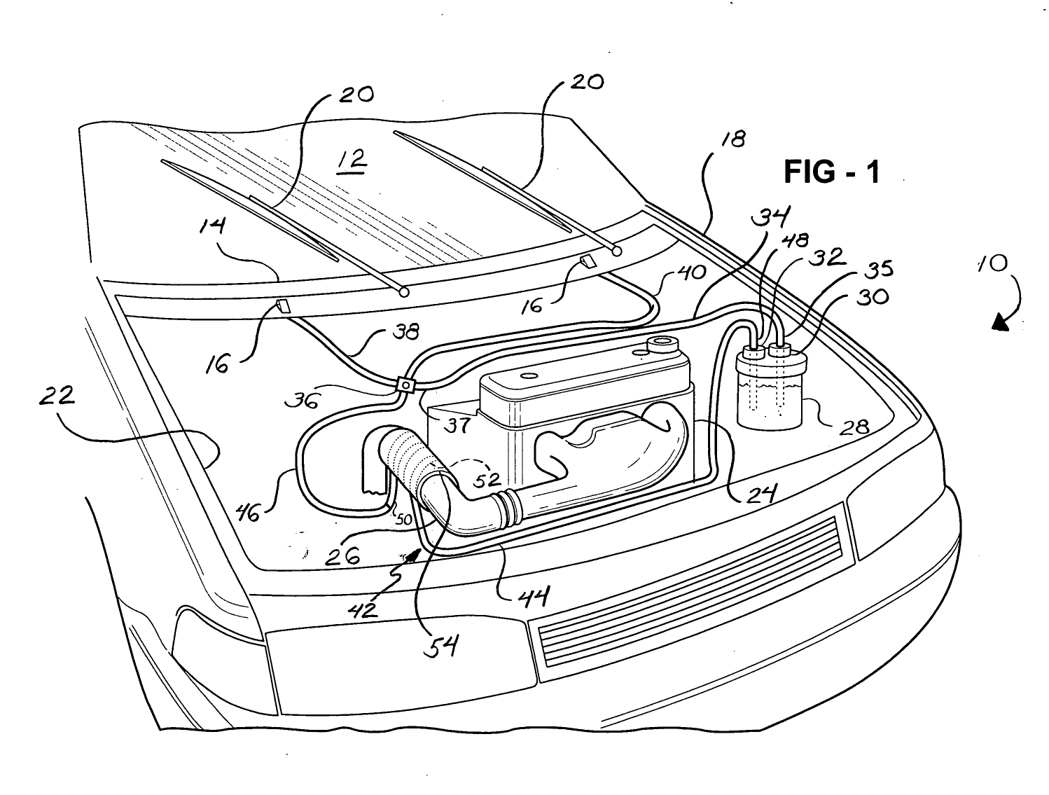

Referring to FIG. 1, a motor vehicle 10 includes a front windshield 12 having a bottom edge 14. A pair of nozzles 16 is fixedly mounted along a body portion 18 of the motor vehicle 10 adjacent the bottom edge 14 of the front windshield 12. The nozzles 16 spray a quantity of washer fluid onto the front windshield 12. The washer fluid on the front windshield 12 is wiped clean by at least one windshield wiper 20.

The body portion 18 of the motor vehicle 10 defines an engine compartment 22. The engine compartment 22 houses an internal combustion engine 24 having a manifold 26. A fluid reservoir 28 is disposed within the engine compartment 22 at a distance away from the engine 24 for storing a supply of washer fluid. The fluid reservoir 28 includes first 30 and second 32 pump assemblies for selectively pumping washer fluid from the fluid reservoir 28 to the nozzles 16.

A tubular member 34 has one end 35 connected to the first pump assembly 30 and an opposing end 37 connected to a thermostat or regulator 36. The thermostat 36 controls the flow of washer fluid to first 38 and second 40 nozzle delivery tubes. Once the washer fluid is transferred to the first 38 and second 40 delivery tubes, the washer fluid is sprayed onto the front windshield 12 by the nozzles 16.

The above-described system works well in a majority of weather conditions. However, there are situations, i.e., cold weather conditions, in which the front windshield 12 is iced over. In these situations, the washer fluid in the above-described systems does not effectively de-ice the front windshield 12.

A heated washer fluid assembly, generally shown at 42, according to the invention provides heated washer fluid for de-icing the front windshield 12 upon contact therewith. The heated washer fluid assembly 42 includes a heat-resistant first conduit 44 and a second conduit 46. The first conduit 44 includes a receiving end 48 operatively connected to the second pump assembly 32, and a delivery end 50 fluidly connected to the second conduit 46.

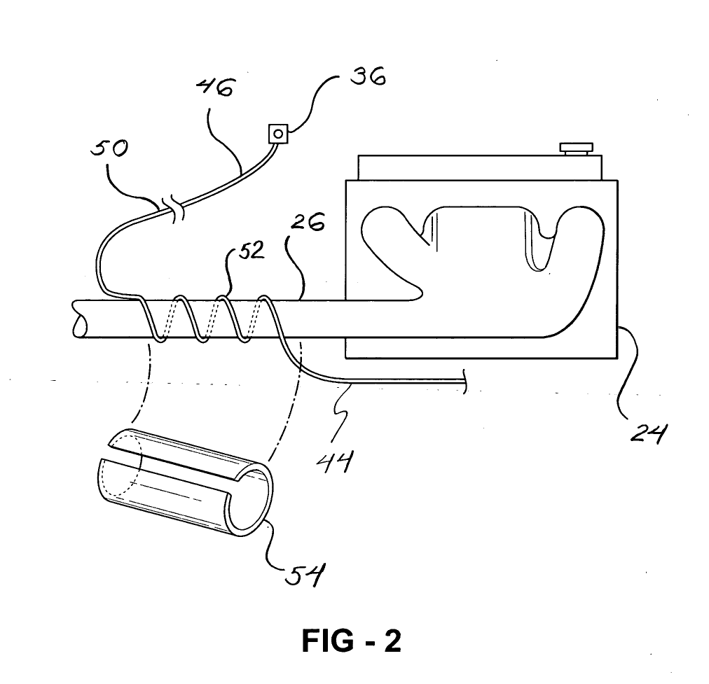

Referring to FIG. 2, the first conduit 44 also includes a middle segment 52 that abuts a portion of the internal combustion engine 24. In a preferred embodiment, the middle segment 52 is wrapped around a portion of the manifold 26 of the internal combustion engine 24. Thus, the middle segment 52 is in contact with the manifold 26, which heats up quickly when the internal combustion engine 24 is started. As a result, the washer fluid passing through the middle segment 52 travels repeatedly around the manifold in a circular motion and absorbs heat generated by the internal combustion engine 24. Although the manifold 26 of the internal combustion engine 24 has been set forth herein, it is appreciated that the middle segment 52 of the first conduit 44 may, in the alternative, contact other heated portions of the internal combustion engine 24.

A blanket 54 covers the portion of the manifold 26 and the middle segment 52 of the first conduit 44 wrapped around the manifold 26. The blanket 54, which is formed from a heat-absorbent material, insulates the washer fluid to prevent the washer fluid in the middle segment 52 from losing heat. In the preferred embodiment, the washer fluid is heated to a temperature between approximately 130° F. and 170° F. Because the manifold 26 heats up within approximately 15 seconds of the starting of the internal combustion engine 24, the heated washer fluid assembly 42 is able to provide heated washer fluid to the front windshield 12 within a minimal amount of time after starting the internal combustion engine 24.

The second conduit 46 is positioned away from the manifold 26 and transfers the heated washer fluid from the delivery end 50 of the first conduit 44 to the thermostat 36. It is appreciated that although first 44 and second 46 conduits are disclosed, a single conduit may be utilized between the fluid reservoir 28 and the thermostat 36. The thermostat 36 monitors the washer fluid temperature to ensure that the washer fluid temperature is within the above-mentioned approximate temperature range of 130° F. to 170° F. prior to delivery to the nozzles 16. If the washer fluid temperature is between approximately 130° F. and 170° F., the thermostat 36 will allow the washer fluid to enter the first 38 and second 40 nozzle delivery tubes for eventual spraying onto the front windshield 12 by the nozzles 16. If the heated washer fluid is above approximately 170° F., washer fluid at ambient temperature is introduced from the fluid reservoir 28 via the tubular member 34 and mixed with the heated washer fluid from the second conduit 46 to reduce the temperature of the washer fluid. If the heated washer fluid assembly 42 is activated within approximately 15-30 seconds of starting the engine 24, the temperature of the washer fluid will be between ambient temperature and approximately 130° F. until there is enough heat available to raise the temperature of the washer fluid passing through the middle segment 52 of the first conduit 44 to at least 130° F.

The operation of the heated washer fluid assembly 42 according to the invention is as follows. Once an operator starts the internal combustion engine 24, the manifold 26 heats up very quickly, typically within approximately 15 seconds. If the operator activates the heated washer fluid assembly 42 within 15-30 seconds of the starting of the internal combustion engine 24, the washer fluid delivered to the nozzles 16 via the first conduit 44 will be that washer fluid already present in the first conduit 44, which is at a temperature close to ambient temperature. However, once the manifold is sufficiently heated, the washer fluid passing through the middle segment 52 of the first conduit 44, which is wrapped around a portion of the manifold 26, is heated via the heat generated by the engine 24 to a temperature between approximately 130° F. and 170° F. The blanket 54, which covers the middle segment 52, insulates the heated washer fluid. The heated washer fluid is transferred from the delivery end 50 of the first conduit 44 to the second conduit 46. The heated washer fluid then reaches the thermostat 36, which controls the flow of washer fluid to the nozzles 16. If the washer fluid is between approximately 130° F. and 170° F., the washer fluid is conveyed to the nozzles 16 via the first 38 and second 40 nozzle delivery tubes for spraying onto the front windshield 12. If the heated washer fluid is above approximately 170° F., washer fluid at ambient temperature is introduced from the fluid reservoir 28 via the tubular member 34 and mixed with the heated washer fluid from the second conduit 46 to reduce the temperature of the washer fluid. Once the heated washer fluid assembly 42 is deactivated, the heated washer fluid will remain in the nozzle delivery tubes 38, 40 and the first 44 and second 46 conduits for additional spraying when needed.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

1. A heated washer fluid assembly for heating washer fluid to clean a windshield of a motor vehicle having an engine and a fluid reservoir, said heated washer fluid assembly comprising:
a conduit having a receiving end fluidly connected to the fluid reservoir and an opposing delivery end for transferring washer fluid from the fluid reservoir to said delivery end, said conduit including a middle segment disposed between said receiving and delivery ends and abutting a portion of the engine such that washer fluid passing through said middle segment is heated by the heat generated by the engine; and
a blanket covering said middle segment of said conduit and the portion of the engine for insulating the heated washer fluid in said middle segment of said conduit.

2. A heated washer fluid assembly as set forth in claim 1 including a pump assembly coupled to the fluid reservoir for pumping washer fluid from the fluid reservoir into said conduit.

3. A heated washer fluid assembly as set forth in claim 2 wherein said blanket is formed from a heat-absorbent material.

4. A heated washer fluid assembly as set forth in claim 3 wherein said conduit is formed from a heat-resistant material.

5. A heated washer fluid assembly as set forth in claim 4 wherein said washer fluid is heated to a temperature between approximately 130° F. and 170° F.

6. A heated washer fluid assembly as set forth in claim 5 including a thermostat fluidly interconnected between said conduit and the windshield for controlling the flow of heated washer fluid thereto.

7. A method for heating washer fluid stored in a fluid reservoir of a motor vehicle including an engine, a conduit coupled to the fluid reservoir and having a middle segment abutting a portion of the engine, and a blanket covering the portion of the engine, the method comprising the steps of:
transferring the washer fluid from the fluid reservoir to the conduit;
heating the washer fluid via heat generated by the engine as the washer fluid passes through the middle segment of the conduit abutting the portion of the engine;
insulating the washer fluid with the blanket as the washer fluid is heated within the middle segment of the conduit; and
conveying the heated washer fluid from the conduit to the windshield.

8. A method as set forth in claim 7 including the step of controlling the flow of the heated washer fluid from the conduit to the windshield.

9. A method as set forth in claim 8 wherein the step of heating the washer fluid via heat generated by the engine as the washer fluid passes through the middle segment of the conduit abutting the portion of the engine includes the step of heating the washer fluid to a temperature between approximately 130° F. and 170° F.
